(19) United States
(12) Patent Application Publication
(10) Pub. No.: US 2025/0086741 A1
(43) Pub. Date: Mar. 13, 2025

(54) METHODS AND SYSTEMS FOR FACILITATING EVALUATING LEARNING OF A USER

(71) Applicant: Naim Ulhasan Syed, Canterbury, NH (US)

(72) Inventor: Naim Ulhasan Syed, Canterbury, NH (US)

(73) Assignee: Janet Syed, Canterbury, NH (US)

(21) Appl. No.: 18/510,851

(22) PCT Filed: Nov. 16, 2023
(86) PCT No.: PCT/US2022/029688

§ 371 Date: Nov. 16, 2023

Related U.S. Application Data
(60) Provisional application No. 63/189,262, filed on May 17, 2021.

(30) Foreign Application Priority Data
Nov. 16, 2023 (WO) PCT/US2022/029688

(51) Int. Cl. G06Q 50/20

(52) U.S. Cl. CPC G06Q 50/20

(57) ABSTRACT

The present invention is an adaptive learning platform featuring a content engine to deliver lessons from teachers to students, an assessment engine that tests student knowledge and provides instant feedback to teachers and students, a communication engine to facilitate messages and ratings between teachers and students, and a teacher/administrator dashboard for managing student and teacher registration, viewing and comparing student scores, inputting and scaffolding lesson plans and assessments, and initiating student assessments.

### FIELD OF THE INVENTION

The present invention relates generally to data processing. More specifically, the present invention is methods and systems for facilitating evaluating learning of a user.

### BACKGROUND OF THE INVENTION

The field of data processing is technologically important to several industries, business organizations, and/or individuals. In particular, the use of data processing is prevalent for evaluating the learning of a user in education and training.

Existing techniques for evaluating the learning of a user are deficient in several aspects. For instance, current technologies include one-directional teaching by an individual teacher to a plurality of students where a student memorizes a concept without real-time assessment of students learning. While one-directional teaching may work in a synchronous environment either in-person or live online, this is not the reality for a great deal of online instruction, which occurs asynchronously as pre-recorded lessons are viewed on a student's own time. Because of the time lag between instruction and assessment online, current technologies do not allow the teacher to effectively evaluate a student's learning of the concept in real-time. Further, the students are examined for material and not for knowledge. Moreover, current technologies do not facilitate differentiating a teacher that makes students clearly understand the concepts from other teachers. Further, current technologies do not allow the student to ask for assistance for understanding the concept or for the teacher to initiate specific instruction with a student.

Therefore, there is a need for improved methods and systems for facilitating evaluating learning of a user that may overcome one or more of the above-mentioned problems and/or limitations.

### SUMMARY OF THE INVENTION

The present invention is an adaptive learning platform accessible by teachers and students. The platform comprises a content engine to deliver peer-reviewed lessons from teachers to students, with certain content “scaffolded” to provide just-in-time intervention based on answers provided by students in assessments and specific teacher feedback. The platform further comprises an assessment engine that tests student knowledge in both formative and summative assessments and provides instant feedback to teachers and students. The platform further comprises a communication engine to facilitate messages and ratings between teachers and students. The platform further comprises a teacher and administrator dashboard for managing student and teacher registration, viewing and comparing student scores, inputting and scaffolding lesson plans and assessments, and manually initiating student assessments. Certain assessment results from students, either based on a certain percentage of questions missed or specific questions missed, may be configured on the dashboard to instantly trigger related teachers so that intervention can begin.

According to some embodiments, a method for facilitating evaluating learning of a user is disclosed. Accordingly, the method may include receiving, using a communication device, a teaching request from at least one user device associated with the at least one user. Further, the method may include retrieving, using a storage device, teaching content based on the teaching request. Further, the method may include transmitting, using the communication device, the teaching content to at least one second user device associated with at least one second user. Further, the method may include receiving, using the communication device, a request from the at least one user device associated with the at least one user. Further, the method may include processing, using a processing device, the request to generate an assessment initiation alert. Further, the method may include transmitting, using the communication device, the assessment initiation alert to the at least one user device. Further, the method may include receiving, using the communication device, an assessment module from the at least one user device. Further, the method may include transmitting, using the communication device, the assessment module to at least one second user device. Further, the method may include receiving, using the communication device, response data corresponding to the assessment module from the at least one second user device. Further, the method may include retrieving, using a storage and computing device, a scaffolding model that is customizable by the teacher. This model may be used to analyze student performance and tailor certain future instructions or assessments based on the total number of questions answered correctly or specific questions that may be configured. Further, the method may include generating, using the processing device, an assessment result based on the analysis. Further, the method may include transmitting, using the communication device, the assessment result to at least one of the at least one user device and the at least one second user device. Further, the method may include receiving, using the communication device, an instructional data from the at least one user device dynamically based on the assessment result. Further, the method may include transmitting, using the communication device, the instructional data to the at least one second user device. Further, the method may include storing, using the storage device, at least one of the assessment result, the response data, the instructional data, and the assessment module on a blockchain.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants.

In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow diagram detailing the three main engines: content, assessment, and communication of the present invention FIG. 4 is a flow diagram detailing a possible scaffolding for theoretical lessons A, B, and C.

FIG. 5 is a flow diagram detailing a possible scaffolding for theoretical lessons A, B, C, and D.

FIG. 6 is a flow diagram detailing communication between teachers and students.

FIG. 7 is a flow diagram detailing storage and access to student assessment data.

FIG. 8 is a flow diagram detailing the sensor function to detect cheating with audio/visual input.

FIG. 9 is a sample diagram showing results for two students with differently scaffolded lesson plans.

FIG. 10 is a sample diagram showing the interface of FIG. 9 nested in an interface to read and respond to student messages.

FIG. 11 is a sample diagram showing review of a student's current response to a question, along with that question's response history.

### DETAILED DESCRIPTION OF THE INVENTION

All illustrations of the drawings are for the purpose of describing selected versions of the present invention and are not intended to limit the scope of the present invention.

The present disclosure describes methods and systems for facilitating evaluating learning of a student. Further, the disclosed system is a lesson building software platform that uses algorithms to provide dynamic learning based on performance of the student. Further, the disclosed system may be configured for reviewing the student's answers in real-time by a teacher. Further, the software platform may connect to a data file, such as an excel sheet, that captures the students' answers. Further, the disclosed system captures information associated with the data file and displays the information on a dashboard, accessible by one or more teachers assigned to the student, showing the answers and the details of the answers.

The disclosed system fetches the information in real-time and displays it on the dashboard. To evaluate the student's learning, the system includes several features. First, the disclosed system may give information about the student's time spent on each assessment. Second, the disclosed system may be configured for checking if the student has made a mistake in their answer or if the student has skipped a question, with results visible to either the teacher or the student. Third, the disclosed system may be configured for comparing the results of a student with the rest of the class, either in table or graph form, to help evaluate if the instructions need to be enhanced or a student needs intervention. Fourth, the disclosed system may allow scaffolding of assessments, such that a certain number of incorrect answers, or missing a specific question on the scaffolded assessment may lead to different instruction and questions compared to adequate performance. The disclosed system is configured to allow editing of student information, questions, and instruction by teachers and administrators, with various privileges given to teachers based on their assigned students, and to administrators based on their assigned roles.

The disclosed system may be configured for writing to an output file when the student answers a question. Further, the disclosed system displays and compares the student's responses with other student's responses on a dashboard. Further, the teacher may monitor all the response information online, using the dashboard, or offline by manually accessing the data file. Further, the disclosed system may be configured for providing the results on either the internet or on a local intranet. Further, the disclosed system may be configured for providing one-to-one teaching lessons to the student by a teacher, one-to-many teaching lessons to many students by a teacher, or many-to-many teaching lessons to many students by many teachers. Further, the disclosed system may be configured for monitoring student learning. Further, the disclosed system may be configured for differentiating a teacher from other teachers based on the monitoring of students learning, such that some teachers may be assigned different access roles from other teachers. Further, the disclosed system may be configured for assessing the students individually to check their learning. Further, the disclosed system may be configured for performing formative assessment and summative assessment in the lessons. Formative assessments comprise simple quizzes and activities to check short-term knowledge retention, while summative assessments comprise tests that require synthesis of larger amounts of data long-term. Further, the disclosed system may be configured for scaffolding lessons based on assessment results, with certain lessons or questions made available based on whether previous questions were answered correctly.

Finally the disclosed system may include a self-assessment platform where a student can record a rating of the lesson or instructor, or the student can record a personal message to the teacher for direct intervention. Ratings of the instructors may be either a binary “thumbs up” or “thumbs down,” or a star rating system on a numerical scale.

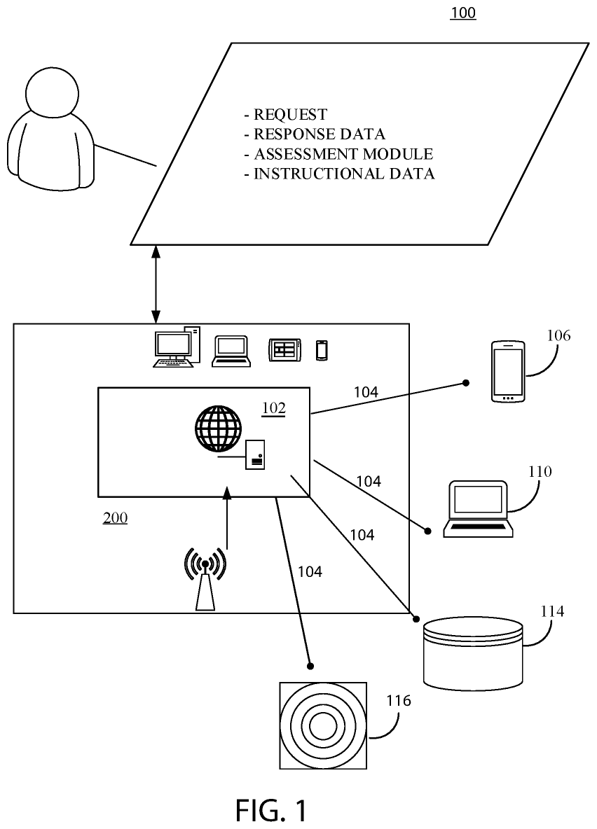

FIG. 1 is an illustration of an online platform 100 consistent with various embodiments of the present disclosure. By way of non-limiting example, the online platform 100 for facilitating evaluating learning of a user may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114 to store lessons, assessments, and AI data, and sensors 116 over a communication network 104, such as, but not limited to, the Internet.

Further, users of the online platform 100 may include relevant parties such as, but not limited to, end-users, service providers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 200.

Further disclosed herein is a system for facilitating evaluating learning of a user. Accordingly, the system may include a communication device configured for receiving a teaching request from at least one user device associated with the at least one user.

Further, the at least one user may include an individual, an institution, and an organization. Further, in an instance, the at least one user may include a teacher, an instructor, etc. Further, the at least one user device may include a laptop, a smartphone, a tablet, a personal computer, and so on. Further, the teaching request may be associated with at least one concept that the at least one user may want to teach at least one student. Further, the at least one concept (such as friction) may be associated with a subject (such as physics, chemistry, etc.) of an academic branch (such as science, philosophy, arts, commerce, etc.).

Further, the communication device may be configured for transmitting teaching content to at least one second user device associated with at least one second user.

Further, in an instance, the at least one second user may include a learner. Further, the at least one second user device may include a laptop, a smartphone, a tablet, a personal computer, and so on. Further, the teaching content may include audio content, video content, image, etc. associated with the at least one concept. Further, the teaching content may include key knowledge concepts, illustrations, real-life examples, animations, practice sets, exemplary questions, etc.

Further, the communication device may be configured for receiving a request from the at least one user device. Further, the request may correspond to the at least one user that may want to evaluate learning of at least one student. Further, the communication device may be configured for transmitting an assessment initiation alert to the at least one user device. Further, the communication device may be configured for receiving an assessment module from the at least one user device. Further, the assessment module may include a questionnaire for evaluating the student learning of the at least one second user. Further, the communication device may be configured for transmitting the assessment module to the at least one second user device. Further, the at least one second user may include an individual that may want to attempt the assessment module. Further, the communication device may be configured for receiving response data corresponding to the assessment module from the at least one second user device. Further, the response data may include answers corresponding to the questionnaire. Further, the communication device may be configured for transmitting the assessment result to at least one of the at least one user device and the at least one second user device. Further, the communication device may be configured for receiving instructional data from the at least one user device based on the assessment result. More specifically, instructional data may be configured such that different instruction is sent based on how many questions were answered correctly, or whether certain fundamental questions were answered correctly in the assessment. Further, the instructional data may include a video content, an audio content, an image, or other embedded media that may provide assistance corresponding to the assessment module to the at least one second user. Further, the communication device may be configured for transmitting the instructional data to the at least one second user device.

Further, the system may include a processing device configured for processing the request to generate the assessment initiation alert. Further, the processing device may be configured for analyzing the response data based on an artificial intelligence model. Further, the processing device may be configured for generating the assessment result based on the analyzing. Further, the assessment result may include a score corresponding to the assessment module. Further, the assessment result may include performance indicators associated with the evaluation of the at least one second user. Further, the performance indicators may include time spent on a question of the questionnaire, accuracy, peer response, relative accuracy, etc. These performance indicators may be logged in a secure database to help predict future outcomes and scaffold future lessons and assessments for students. Further, the performance indicators may be used in artificial intelligence models that incorporate flexible learning pathways, mind mapping, and outcome mapping to deliver the most appropriate instruction and assessments to students. The system may automatically raise alerts based on student performance, and teachers may also monitor student performance, manually raise alerts with students, or set up automatic alerts based on assessment performance.

Further, the system may include a storage device configured for retrieving the teaching content based on the teaching request. Further, the storage device may be configured for retrieving the artificial intelligence model. Further, the artificial intelligence model may include a machine learning model. Further, the storage device may be configured for storing at least one of the assessment result, the response data, the instructional data, and the assessment module on a blockchain.

Further disclosed herein is a method for facilitating evaluating learning of a user. Accordingly, the method may include receiving, using a communication device, a teaching request from at least one user device associated with the at least one user.

Further, the at least one user may include an individual, an institution, and an organization. Further, in an instance, the at least one user may include a teacher, an instructor, etc. Further, the at least one user device may include a laptop, a smartphone, a tablet, a personal computer, and so on. Further, the teaching request may be associated with at least one concept that the at least one user may want to teach at least one student. Further, the at least one concept (such as friction) may be associated with a subject (such as physics, chemistry, etc.) of an academic branch (such as science, philosophy, arts, commerce, etc.).

Further, the method may include retrieving, using a storage device, teaching content based on the teaching request. Further, the teaching content may include audio content, video content, image, etc. associated with the at least one concept. Further, the teaching content may include key knowledge concepts, illustrations, real-life examples, animations, practice sets, exemplary questions, etc.

Further, the method may include transmitting, using the communication device, the teaching content to at least one second user device associated with at least one second user. Further, in an instance, the at least one second user may include a learner. Further, the at least one second user device may include a laptop, a smartphone, a tablet, a personal computer, and so on.

Further, the method may include receiving, using the communication device, a request from the at least one user device associated with the at least one user. Further, the request may correspond to the at least one user that may want to evaluate learning of the at least one student.

Further, the method may include processing, using a processing device, the request to generate an assessment initiation alert.

Further, the method may include transmitting, using the communication device, the assessment initiation alert to the at least one user device.

Further, the method may include receiving, using the communication device, an assessment module from the at least one user device. Further, the assessment module may include a questionnaire for evaluating the student learning of the at least one second user.

Further, the method may include transmitting, using the communication device, the assessment module to the at least one second user device. Further, the at least one second user may include an individual that may want to attempt the assessment module.

Further, the method may include receiving, using the communication device, response data corresponding to the assessment module from the at least one second user device. Further, the response data may include answers corresponding to the questionnaire. Further, in an instance, the response data may include an excel sheet comprising answers associated with the questionnaire.

Further, the method may include retrieving, using a storage device, an artificial intelligence model. Further, the artificial intelligence model may include a machine learning model.

Further, the method may include analyzing, using the processing device, the response data based on the artificial intelligence model. The method may include collecting data based on subject, topic, or concept, assessment scores, and type of intervention, and logging relevant data to a secure server to help predict future interventions.

Further, the method may include generating, using the processing device, an assessment result based on the analysis. Further, the assessment result may include a score corresponding to the assessment module. Further, the assessment result may include performance indicators associated with the evaluation of the at least one second user. Further, the performance indicators may include time spent on a question of the questionnaire, accuracy, peer response, relative accuracy, etc. Further, the method may include transmitting, using the communication device, the assessment result to at least one of the at least one user device and the at least one second user device.

Further, the method may include receiving, using the communication device, an instructional data from the at least one user device based on the transmitting of the assessment result. Further, the instructional data may include a video content, an audio content, an image, or other embedded media that may provide assistance corresponding to the assessment module to the at least one second user.

Further, the method may include transmitting, using the communication device, the instructional data to the at least one second user device.

Further, the method may include storing, using the storage device, at least one of the assessment result, the response data, the instructional data, and the assessment module on a blockchain.

Further, in an embodiment, the method may include receiving, using the communication device, an assistance request from the at least one second user device.

Further, the method may include transmitting, using the communication device, the assistance request to the at least one user device. Further, the method may include receiving, using the communication device, a helping response associated with the assistance request. Further, the helping response may correspond to the at least one user that may want to assist the at least one second user. Further, the transmitting of the instructional data may be based on the helping response. Further, in an embodiment, the method may include analyzing, using the processing device, at least one of the assessment module, the response data, the instructional data, the assistance request, the helping response, and the assessment result to generate an instructor credit. Further, the instructor credit may include ranking corresponding to the at least one user. Further, the ranking may include a star ranking. Further, the instructor credit may facilitate identifying a good instructor from a plurality of instructors (such as the at least one user). Further, the method may include transmitting, using the communication device, the instructor credit to at least one user device and at least one management device. Further, the management device may be associated with an administrator or management authority of an institution (such as coaching institute, a school, a college, etc.). Further, the at least one management device may include a smartphone, a tablet, a laptop, or other device with internet access.

Further, in an embodiment, the response data may include a first student response data associated with a first student and a second student response data associated with a second student. Further, the method may include analyzing, using the processing device, the first student response data and the second student response data based on the artificial intelligence model to determine a comparison result. Further, the comparison result may facilitate comparing performance, associated with the assessment module, of the first student and the second student. Further, the performance may be associated with learning capability. Further, the method may include transmitting, using the processing device, the comparison result to the at least one user device and the at least one second user device.

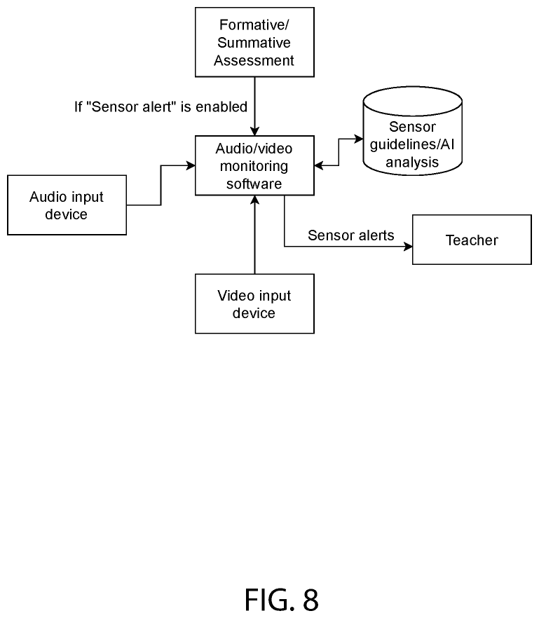

Further, in an embodiment, the method may include receiving, using the communication device, sensor data from at least one sensor, detailed in FIG. 8. Further, the at least one sensor may include an audio sensor, an image sensor, etc. Further, the at least one senor may be configured for detecting activity of the at least one second user while attempting the assessment module. Further, in an instance, the at least one sensor may be disposed on the at least one second user device. Further, in a second instance, the at least one sensor may be disposed in an environment of the at least one second user device. Further, the method may include retrieving, using a storage device, a second artificial intelligence model. Further, the second artificial intelligence model may include a machine learning model. Further, the method may include analyzing, using the processing device, the sensor data based on the second artificial intelligence model to determine a malpractice alert. Further, the malpractice alert may be associated with a malpractice performed by the at least one second user while attempting the assessment module. Further, the malpractice may include cheating, use of unfair means (such as calculator, books, etc.), etc. Further, the method may include transmitting, using the processing device, the malpractice alert to the at least one user device.

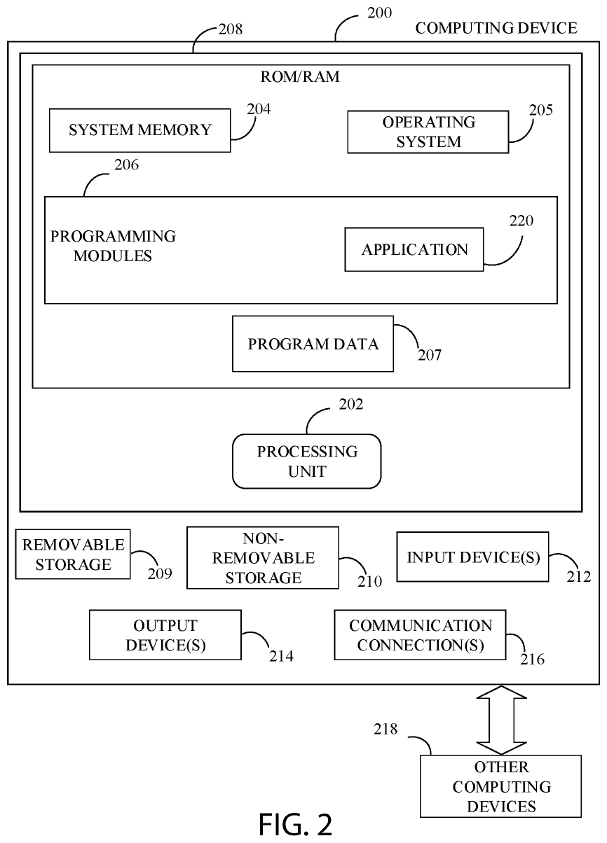

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and nonvolatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory

technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media.

Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include sound encoding/decoding applications, machine learning application, acoustic classifiers, etc.

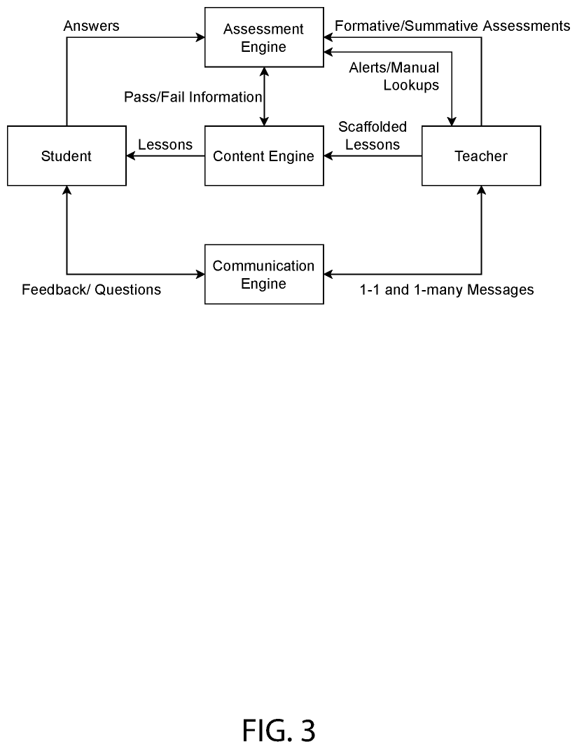

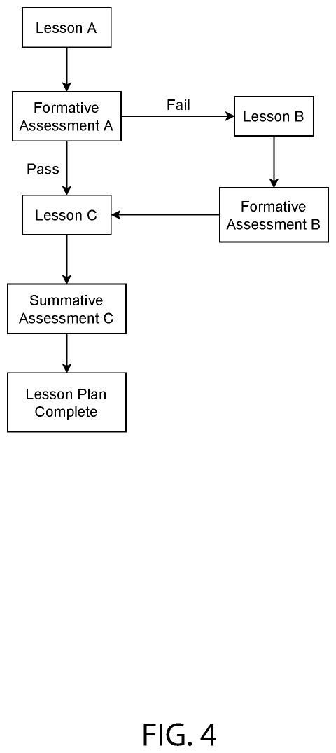

FIG. 3 details the three main engines of the present invention and the general flow of information between student and teacher. The teacher first prepares lessons for students and then formative and summative assessments. The lessons may be “scaffolded” together with the assessments so that passing or failing an assessment may lead to different lessons and assessments required. As a student completes the lessons and assessments, responses are sent to the assessment engine. In order to deliver the appropriate next lesson, pass/fail information is shared between the assessment engine and the content engine. Teachers or administrators may configure alerts to be sent, such as when a certain number of answers is answered incorrectly, or if too much time is taken to respond to questions. Based on these alerts, or through manually looking up student data, teachers may send text communications to students individually, or if certain problems persist among groups of students, to select groups or whole classes at once. Similarly, as the student completes lessons and answers questions in the assessment, an option is available to “raise their hand” and provide feedback or questions to the teacher. A log of the student's lesson or assessment/question is sent, along with their question or feedback.

FIG. 4 details a sample of “scaffolding” lessons and assessments so a student that passes a first assessment (“Formative Assessment A”) may skip a second lesson and assessment (“Formative Assessment B”) and proceed straight to a third lesson and assessment (“Summative Assessment C”). Determination of what is “passing” and “failing” an assessment is determined by the teacher and may either include a set percentage requirement for all questions, or a required number in a subset of selected questions out of the assignment that are deemed essential.

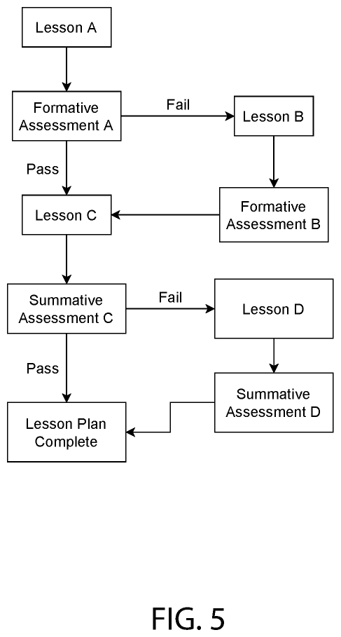

FIG. 5 shows a more complex sample of scaffolding lessons and assessments so that a student must also pass a summative assessment before completing the lesson plan. Summative assessments often cover more material and require synthesis of previously learned data that may be relatively old. Formative assessments, on the other hand, usually check short-term knowledge of recently learned data. Teachers may customize thresholds based on the assessment for both formative and summative assessments so that certain lessons are provided based on objective pass/fail requirements. Sometimes students may even need to re-take lessons or assessments after failing assessments once or repeatedly.

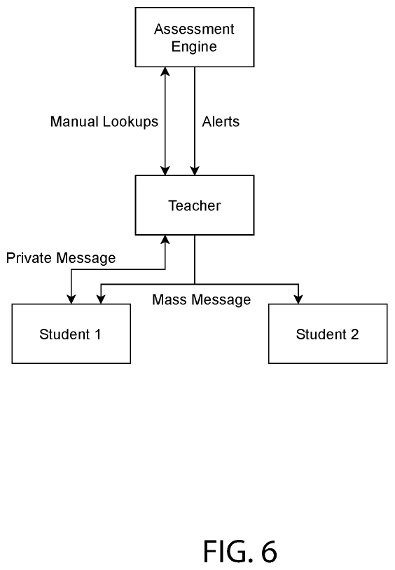

FIG. 6 details the alerts and communications system between teachers and students. Alerts may be configured by teachers on the assessment engine, much like lesson scaffolding, to automatically notify teachers of certain student performance benchmarks. These benchmarks may include certain scores, certain questions missed, number of times questions are missed, or if the student is taking too long to answer questions. Custom alerts may be configured for other variables recorded for each student. Teachers may also manually look up a student's assessment results and initiate a private conversation. In addition to private conversations 1-1 with students, teachers may initiate mass messages with multiple students.

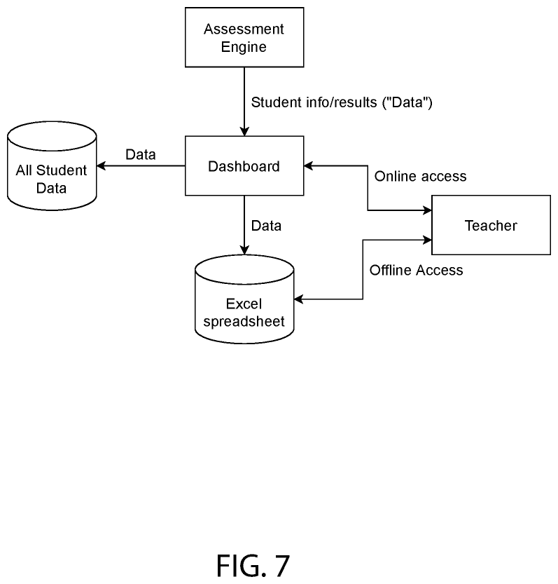

FIG. 7 details a method of making visible a student's personal information and their assessment results on an online dashboard, as part of the assessments engine. The same data is also passed to a database of all student data and an excel spreadsheet on a local computer accessible by the teacher. The teacher may then access the student data online using the dashboard, or offline using the excel spreadsheet.

The excel spreadsheet serves as an offline backup and simple solution for the teacher to access files without logging in to an online dashboard. Access to the dashboard and excel spreadsheet may be further configured to use the internet or intranet. The dashboard serves as a sort of scorekeeping for students and keeps track of the number of attempts, skips, and answers of a question, along with time spent on each attempt. If the student raises a question this is logged in the dashboard. Similarly, if the teacher intervenes or responds to the raised question this is logged in the dashboard. Finally, the student may complete a feedback survey just after completing a content or formative assessment, which is logged in the dashboard.

FIG. 8 details a method of using a sensor to monitor students during certain assessments, if enabled by the teacher, using audio input devices, such as a microphone, or video input devices, such as a camera. Alerts based on certain sound or video may be configured by the teacher. In addition the sound and video is stored in a database and continuously analyzed with artificial intelligence to predict cheaters, given a list of known cheaters.

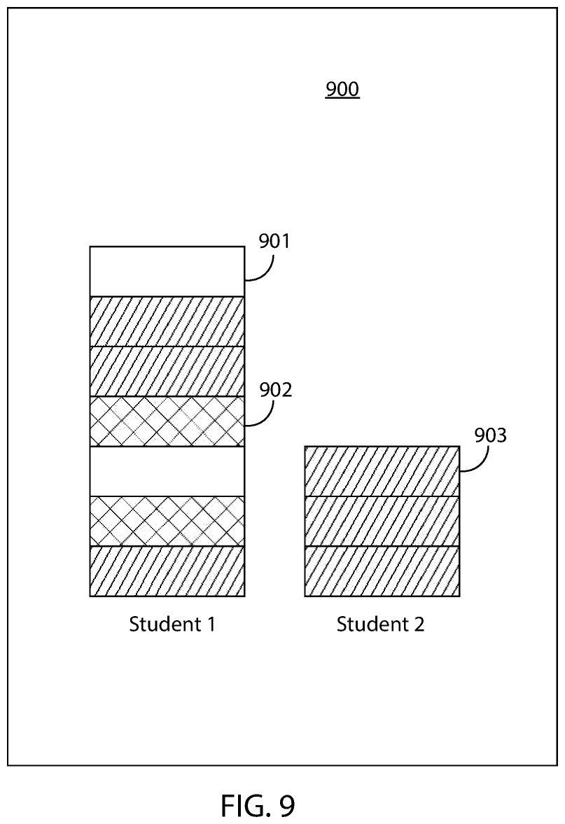

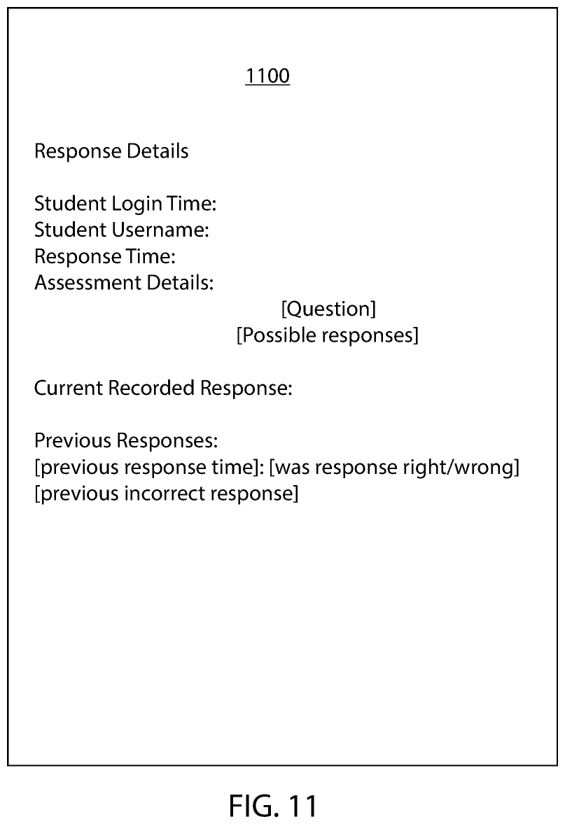

FIG. 9 shows a sample display 900 of two students' answers compared across multiple assignments. In the sample display 900, the first student (Student 1) has skipped a question 901, as shown by a blank pattern, and missed a question 902, as shown by a double cross-hatched pattern. The second student has answered all three questions correctly, including question 903, as shown by a single cross hatched pattern. Further, it is clear from the diagram that the first student had to complete additional questions according to their teacher's lesson/assessment scaffolding. When viewing the student responses in a graphical user interface, the teacher may select a response and proceed to the interface 1100 shown in FIG. 11, showing response details that include login time, username, response time, assessment details, the current response, and previous responses.

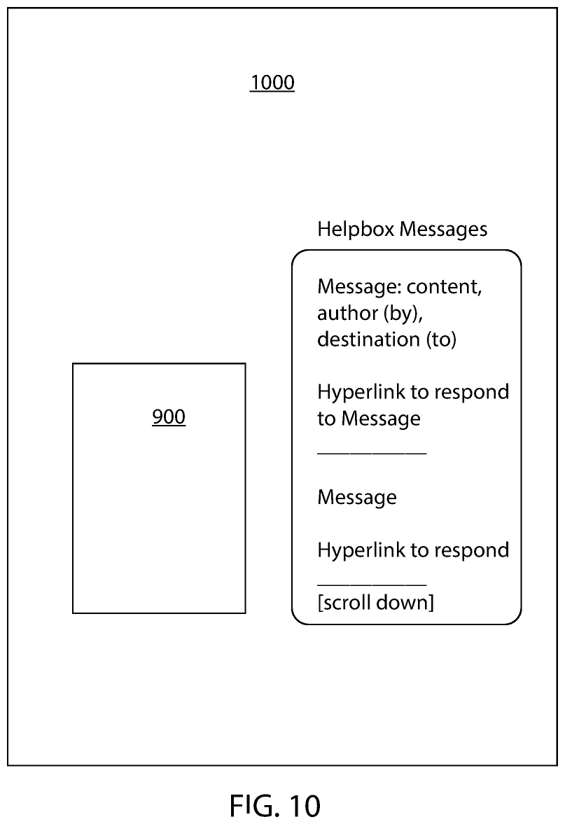

FIG. 10 shows an expanded sample display 1000, including the display 900 showing students' answers, along with any questions or comments the students may have had while completing the assignment.

Although the invention has been explained in relation to its preferred embodiment, it is to be understood that many other possible modifications and variations can be made without departing from the spirit and scope of the invention.

What is claimed is:

1. A system and method for a teacher to evaluate a student's learning comprising:
a content platform delivering a plurality of lessons to the student,
an assessments platform delivering a plurality of assessments to the student,
and a communication platform between the student and the teacher;
wherein:
the content platform delivers additional lessons based on passing or failing specific assessments from the plurality of assessments to the student, and
the assessments platform delivers additional plurality of assessments based on passing or failing specific assessments from the plurality of assessments to the student; wherein:
the assessments comprise either formative or summative assessments; wherein formative assessments are short-term tests of learning and summative assessments are tests concerning long-term synthesis of knowledge; and wherein:
the student may input a custom message to the teacher during one of the plurality of lessons or one of the plurality of assessments;
and wherein:
the assessments platform provides to the teacher specific student information comprising time to answer each question from the plurality of assessments to the student, whether each question from the plurality of assessments was answered correctly or skipped, and any custom message input from the student.

2. The system and method for a teacher to evaluate a student's learning as claimed in claim 1, wherein:
the assessments platform provides custom alerts to the teacher based on the specific student information.

3. The system and method for a teacher to evaluate a student's learning as claimed in claim 2, further comprising:
a student dashboard for the teacher to view the specific student information for the plurality of students assigned to the teacher and compare each question from the plurality of assessments for each of the plurality of students assigned to the teacher.

4. The system and method for a teacher to evaluate a student's learning as claimed in claim 3, wherein:
the communication platform allows the student to raise a question to the teacher during both lessons and assessments in real-time,
the teacher may send a response using the communication platform, and the student dashboard records the question, the time of the question, the response, and the time of the response.

5. The system and method for a teacher to evaluate a student's learning as claimed in claim 4, further comprising:
a learning engine that collects data on the specific student information and any questions and responses through the communication platform to better identify types of intervention that may be successful or unsuccessful in the future.

6. The system and method for a teacher to evaluate a student's learning as claimed in claim 5, wherein:
the assessments platform delivers one or more additional alerts to the teacher for the student when the learning engine has determined that intervention may be successful for the student.

7. The system and method for a teacher to evaluate a student's learning as claimed in claim 4, wherein:
the teacher accesses the student dashboard through a processing device,
the specific student information is stored locally to the teacher's processing device in an Excel or other easily readable data file to be viewed either online or offline, and
any changes to the specific student information are updated on the teacher's processing device using either an intranet or internet connection.

8. The system and method for a teacher to evaluate a student's learning as claimed in claim 7, further comprising:
an audio or video sensor that records input from the student's personal communication device, and
a plurality of alerts triggered by certain input to the audio or video sensor.
wherein:
any triggered alert from the plurality of alerts is sent to the teacher as possible evidence of cheating.

9. The system and method for a teacher to evaluate a student's learning as claimed in claim 8, further comprising:
an engine for analysing audio or visual input, wherein:
the engine stores audio or visual input and past records of cheating behaviour comprising manual strikes, automatic strikes, and false positives,
the engine analyses input to the audio or visual sensor using artificial intelligence, and
the engine predicts possible cheaters and issues an automatic strike.
